(19) United States
(12) Patent Application Publication
(10) Pub. No.: US 2007/0167883 A1
(43) Pub. Date: Jul. 19, 2007

(54) Device for generating shock waves with a focus area extending in depth

(76) Inventor: Axel Voss, Kreuzlingen (CH)

Correspondence Address: ARNOLD & FERRERA, L.L.P., 2401 FOUNTAIN VIEW DRIVE, SUITE 630, HOUSTON, TX, 77057, US

(21) Appl. No.: 11/605,113

(22) Filed: Nov. 28, 2006

(30) Foreign Application Priority Data
Nov. 29, 2005 (DE) 10 2005 056 905.6

(51) Int. Cl. A61H 1/00; A61H 1/02

(52) U.S. Cl. 601/4

(57) ABSTRACT

The invention relates to a device for generating shock waves with a focus area extending in depth and an attachment for devices for generating shock waves for providing a focus area extending in depth. A device for generating shock waves according to the present invention comprises a reflector with a focus, a shock wave generator located in the focus of the reflector, and a lens or a lens system. The reflector and the lens or the lens system are arranged such that the shock wave of the shock wave generator is transformed into a convergent shock wave, wherein a focus area extending in depth with a depth of more than 8 mm is formed. An attachment for devices for generating shock waves according to the present invention comprises a suitable arrangement of a lens or a lens system on a existing device for generating shock waves such that the shock wave of the shock wave generator is transformed into a convergent shock wave, wherein a focus area extending in depth with a depth of more than 8 mm is formed.

The invention relates to a device for generating shock waves with a focus area extending in depth and an attachment for devices for generating shock waves, for providing a focus area extending in depth.

Nowadays, the generation of shock waves is used in various fields. The best-known field is the therapeutic and cosmetic application in the treatment for instance of calculous diseases (e.g. urolithiasis, cholelithiasis) and the treatment of scars in human and veterinary medicine.

New fields of application relate to dental treatment, the treatment of arthrosis, the ablation of calcerous deposits (e.g. tendinosis calcarea), the treatment of chronic tennis or golfer elbows (so called radial or ulnar epicondylopathy), of chronic discomfort of the shoulder tendons (so called enthesopathy of the rotator cuff), and of chronic irritation of the Achilles tendon (so called achillodynia).

Furthermore, the generation of shock waves is used in the therapy of osteoporosis, periodontosis, non-healing bone fractures (so called pseudoarthrosis), bone necrosis, and similar diseases. Newer trials investigate the application in stem cell therapy.

Furthermore, the generation of shock waves can be used to exert mechanical stress ,e.g. in the form of shearing forces, on cells, wherein their apoptosis is initiated. This happens for example by means of an initiation of the ‘death receptor pathway’ and/or the cytochrome c-pathway and/or a caspase cascade.

The term apoptosis is understood to refer to the initiation of a genetically controlled program, which leads to the ‘cell suicide’ of individual cells in the tissue structure. As a result, the cells concerned and their organoids shrink and disintegrate into fragments, the so-called apoptotic bodies. These are phagocytized afterwards by macrophages and/or adjoining cells. Consequently, the apoptosis constitutes a non-necrotic cell death without inflammatory reactions.

Therefore, the application of shock waves is beneficial in all cases, where it relates to the treatment of diseases with an abased rate of apoptosis, e.g. treatment of tumors or viral diseases.

Additionally, the generation of shock waves can be applied beneficially in the treatment of necrotically changed areas or structures in muscle tissue, especially in tissue of the cardiac muscle, in the stimulation of cartilage assembly in arthritic joint diseases, in the initiation of the differentiation of embryonic or adult stem cells in vivo and in vitro in relation to the surrounding cell structure, in the treatment of tissue weakness, especially of cellulitis, and in the degradation of adipose cells, as well as the activation of growth factors, especially TGF-[beta].

Likewise, the generation of shock waves can be used for avoiding the formation and/or extension of edema, for degradation of edema, for the treatment of ischaemia, rheumatism, diseases of joints, jaw bone (periodontosis), cardiologic diseases and myocardial infarcts, pareses (paralyses), neuritis, paraplegia, arthrosis, arthritis, for the prevention of scar formation, for the treatment of scar formation respectively nerve scarring, for the treatment of achillobursitis and other bone necroses.

Another application relates to the treatment of spinal cord and nerve lesions, for example spinal cord lesions accompanied by the formation of edema.

Shock waves are also applicable for the treatment of scarred tendon and ligament tissue as well as badly healing open wounds.

Such badly healing open wounds and boils are called ulcus or also ulceration. They are a destruction of the surface by tissue disintegration at the dermis and/or mucosa. Depending on what tissue fractions are affected, surfacial lesions are called exfoliation (only epidermis affected) or excoriation (epidermis and corium affected).

Open wounds that can be treated with shock waves comprise especially chronic leg ulcers, hypertensive ischaemic ulcers, varicose ulcers or ulcus terebrans due to a thereby caused improved healing process.

Hitherto existing systems for generating shock waves are directed to generate a focus at a specific, narrowly defined depth of a few millimeters. The systems usually comprise a basis device and a treatment head.

To reach different depths, systems providing different focus depths have been introduced.

The treatment head has either multiple fixedly preset focus depths or a variably adjustable focus depth or multiple treatment heads comprising fixed depths must be used. With fixed focus depths usually three focus depths are used.

The treatment head comprises a device for generating shock waves. For this purpose essentially three principles are available, namely the electro-hydraulic, the piezo-electric and the electro-magnetic principle.

These principles have in common that a shock wave generated in an aqueous medium is converged by means of a reflector and is focused by means of an acoustic lens. The aqueous medium usually is enriched with hydrogen and contains small amounts of palladium.

The systems comprise disadvantages which are outlined in the following.

If the treatment head comprises multiple focus depths, the treatment head often is very large. Due to the different foci the construction is relatively complicated. These systems usually have a corresponding device for generating shock waves assigned to each focus.

If the treatment head comprises a variably adjustable focus depth it is also very large. Construction is even more complicated due to the focus adjustment.

The size of these treatment heads corresponds to their weight. Furthermore, treatment heads for small focus depths are expensive, since they comprise a certain amount of palladium, an extremely expensive metal.

If multiple treatment heads must be used for different focus depths, on the one hand the amount of time for each exchange must be considered, on the other hand multiple treatment heads are a costly investment.

If fixed focus depths are provided, it is a further problem that the ranges between the individual possible foci can be reached only suboptimally.

If, however, a variable focus is provided, this must be adjusted before reaching an optimal result.

Furthermore, reaching different depths during a treatment is necessary for many new forms of therapy. Constantly exchanging the treatment head or newly adjusting the focus depth would lead to a considerable extension of the treatment; also the success of the treatment would be endangered by suboptimal treatment depths.

Starting from these disadvantages, it is the object of the present invention to provide a device for generating shock waves which eliminates the disadvantages of the prior art.

The object is solved by a device for generating shock waves with a focus area extending in depth.

It is furthermore an object of the present invention to provide an attachment for devices for generating shock waves which can be used to equip existing systems and which eliminates the disadvantages of the prior art.

This object is solved by an attachment for shock wave generators transforming the shock wave into a shock wave with a focus area extending in depth.

A device for generating shock waves according to the invention comprises a reflector, a shock source and an acoustic lens. The lens and the reflector are disposed with respect to each other such that a shock wave emanating from the shock source is first reflected at the reflector and then the shock wave is formed by the lens.

The formed shock wave has a form comprising a focus area extending in depth. Since the shock wave travels through the focus area, an effective application in different planes is possible. Such a form is advantageous especially for therapy applications on the musculoskeletal system.

The arrangement of the acoustic lens is essential here. For this reason it is also possible to equip existing systems with a corresponding attachment, for example when refurbishing the treatment head, such that the previous treatment head now provides a focus extending in depth, rendering an exchange unnecessary.

In the following, the invention will be explained in detail with regard to the drawing.

It is shown in

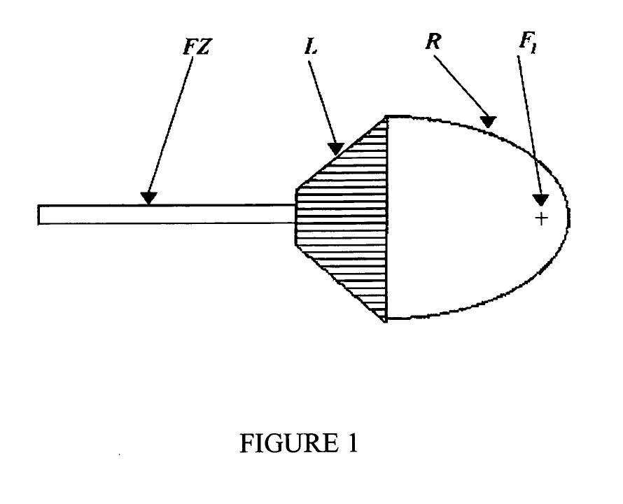

FIG. 1 a schematic illustration of a device for generating shock waves according to the invention.

FIG. 1 shows a schematic illustration of a device for generating shock waves according to the invention.

According to one embodiment of the invention a treatment head comprises a shock wave generator and a reflector. The shock wave generator is arranged such that generation of the shock wave occurs in the focus F₁ of the reflector R.

In the following an electro-hydraulic shock wave generator is assumed. Here a plasma bubble is generated in a liquid by means of a spark discharge in the focus F₁ between two electrodes. This plasma bubble detaches and forms a shock wave.

The generated shock wave spreads from the focus F₁ as a primary divergent shock wave. Thereby at least a part of the divergent wave is reflected by the reflector R.

The reflector R can have a parabolic or an elliptic form.

If the reflector R has an elliptic form, the reflection transforms the reflected part of the divergent shock wave into a convergent shock wave, which converges towards a second focus F₂ and afterwards diverges. If the position of the second focus F₂ is to be changed, an acoustic lens L must be inserted.

If the reflector R has a parabolic form, the reflection transforms the reflected part of the divergent shock wave into a planar shock wave, which travels parallel from the reflector. To generate a further focus in the application area, an acoustic lens L is needed which focuses the shock wave.

Instead of a lens a lens system can be provided. In the following, “lens” is understood to represent either “lens” or “lens system”.

An acoustic lens L comprises a specific index of refraction and a certain form for forming the waves.

By appropriately choosing the material of the lens and the surface of the lens, as well as the position of the acoustic lens L, the focus is transformed into a focal zone extending in depth.

Focal zone is understood the be the zone within which half of the peak pressure is reached, i.e. a -6 dB focus area. The focal zone defmes the area of therapy.

Thus, a broad extension of the area of therapy can be achieved. In a preferred embodiment a depth of about 0 mm to about 120 mm is achieved with an approximate diameter of the area of therapy of 3 mm to 15 mm.

Of course, these parameters of the area of therapy can be changed further by appropriately selecting the position of the lens, such that the depth and/or the cross-sectional area can be varied.

According to a further embodiment of the invention, an existing treatment head can be equipped with an attachment for shock wave generators according to the invention, which transforms the shock wave into a shock wave with a focus area extending in depth.

Thereby, the previous acoustic lens can either be replaced or supplemented with a further acoustic lens.

The attachment is fastened to the device for generating shock waves by means of a suitable fastening device.

F1 focus

FZ focus area

L acoustic lens, acoustic lens system

R reflector

1. Device for generating shock waves with a focus area extending in depth comprising a reflector with a focus, a shock wave generator located in the focus of the reflector, and a lens, characterized in that shock waves, which are generated by the shock wave generator in the focus of the reflector, can be transformed into a focus area extending in depth using the reflector and the lens, wherein the focus area extending in depth comprises a depth of more than 8 mm.

2. Attachment for a device for generating shock waves, comprising a lens, characterized in that shock waves, which are generated by a shock wave generator in the focus of a reflector, can be transformed into a focus area extending in depth using the reflector and the lens, wherein the focus area extending in depth comprises a depth of more than 8 mm.

3. Use of a shock wave generator for the treatment of medical conditions of the musculoskeletal system, characterized in that the device for generating shock waves provides a focus area extending in depth, wherein the device for generating shock waves comprises a reflector with a focus, a shock wave generator located in the focus of the reflector, and a lens, wherein shock waves, which are generated by the shock wave generator in the focus of the reflector, can be transformed into a focus area extending in depth using the reflector and the lens, wherein the focus area extending in depth comprises a depth of more than 8 mm.

4. Use of a shock wave generator for the treatment of medical conditions of the musculoskeletal system, characterized in that the device for generating shock waves comprises an attachment comprising a lens, wherein shock waves, which are generated by a shock wave generator in the focus of a reflector, can be transformed into a focus area extending in depth using the reflector and the lens, wherein the focus area extending in depth comprises a depth of more than 8 mm.
